(19) United States
(12) Patent Application Publication
(10) Pub. No.: US 2018/0370203 A1
(43) Pub. Date: Dec. 27, 2018

(54) Storage of Beauty Products in a Carton

(71) Applicant: Jeanine Longo, Babylon, NY (US)

(72) Inventor: Jeanine Longo, Babylon, NY (US)

(21) Appl. No.: 15/631,700

(22) Filed: Jun. 23, 2017

(51) Int. Cl. B32B 27/10; B32B 29/08; B65D 5/56; B65D 5/42

(52) U.S. Cl. CPC B32B 27/10; B32B 29/08; B32B 27/00; B65D 5/42; B65D 5/563

(57) ABSTRACT

The present invention relates to a carton that satisfies the needs of storing, transporting, and protecting a non-dairy composition from being contaminated by outside elements. The carton comprises a paperboard assembly with a liner that is waterproof, and a non-dairy composition that is housed inside of the paperboard assembly. In one preferred embodiment, a dispenser is affixed to the paperboard assembly. In one preferred embodiment, the carton is in the shape of a cuboid.

The present invention also relates to a method of packaging a non-dairy composition comprising inserting the composition into a carton and sealing the carton so that the contents are sterile.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR COMPUTER PROGRAM LISTING COMPACT DISK APPENDIX

Not Applicable

### BACKGROUND

The present invention relates generally to the technical field of storing non-dairy composition inside of paper containers. More particularly, the present invention is in the technical fields of storing beauty products inside of a carton.

Typically, manufactures use plastic containers to store beauty products. However, there are several disadvantages to using plastic containers for storing beauty products, such as the lack of protecting: (1) the product from outside elements; (2) the product from the plastic container; and (3) the plastic container from the product.

As to the first disadvantage, plastic containers do not protect the product from outside elements. An outside element that is a concern is oxygen, because oxygen molecules can pass through certain plastics. Depending on the chemical composition of the product and its sensitivity to oxygen, the product can chemically react with oxygen; this reaction will cause the product to become less effective and eventually expire for its intended use.

For the second and third disadvantage, the product and plastic can interact chemically with each other. By interacting chemically, the product can comprise the integrity of the plastic container, which can result in leakage. A comprised integrity is a huge issue because plastic containers are constantly subjected to external forces when being shipped by manufacturers or being handled by customers.

Alternatively, the plastic can chemically react with the product and alter the product's chemical formulation. To prevent this product-plastic interaction, manufactures often undergo costly compatibility testing. If the product is not compatible, manufactures will have to use more expensive containers, such as glass containers, to store beauty products.

Therefore, what is needed is a more efficient way to store beauty products and to ship the products in a way that protects the products from being contaminated by outside elements.

### SUMMARY

The present invention relates to a carton that satisfies the needs of storing, transporting, and protecting a non-dairy composition from being contaminated by outside elements. The carton comprises a paperboard assembly with a liner that is waterproof or impervious to liquids, and a non-dairy composition that is housed inside of the paperboard assembly. In one preferred embodiment, a dispenser is affixed to the paperboard assembly. In one preferred embodiment, the carton is in the shape of a cuboid.

The present invention also relates to a method of packaging a non-dairy composition comprising inserting the formulation into a carton and sealing the carton so that the contents are sterile.

The method of packaging a non-dairy composition comprises inserting the non-dairy composition into a carton and sealing the carton so that the non-dairy composition does not become contaminated and remains sterile. The carton further comprises a paperboard assembly and in one preferred embodiment, the carton has a dispenser affixed to the paperboard assembly.

In one preferred embodiment, the non-dairy composition is a liquid beauty product. In one preferred embodiment, the carton is in the shape of a cuboid.

### BRIEF DESCRIPTION OF DRAWINGS

These and other features, aspects, and advantages of the present invention will become better understood with regard to the following description, appended claims, and accompanying drawings where:

FIG. 1 is a perspective view of a carton containing a non-dairy composition in accordance with the principles of the present invention.

FIG. 2 is a perspective view of a carton containing a non-dairy composition with a dispenser affixed to the paperboard assembly in accordance with the principles of the present invention.

FIG. 3 is a cross-sectional view of the carton containing the non-dairy composition of FIG. 2.

FIG. 4 is an enlarged cross-sectional view of the paperboard assembly of FIG. 3.

### DETAILED DESCRIPTION

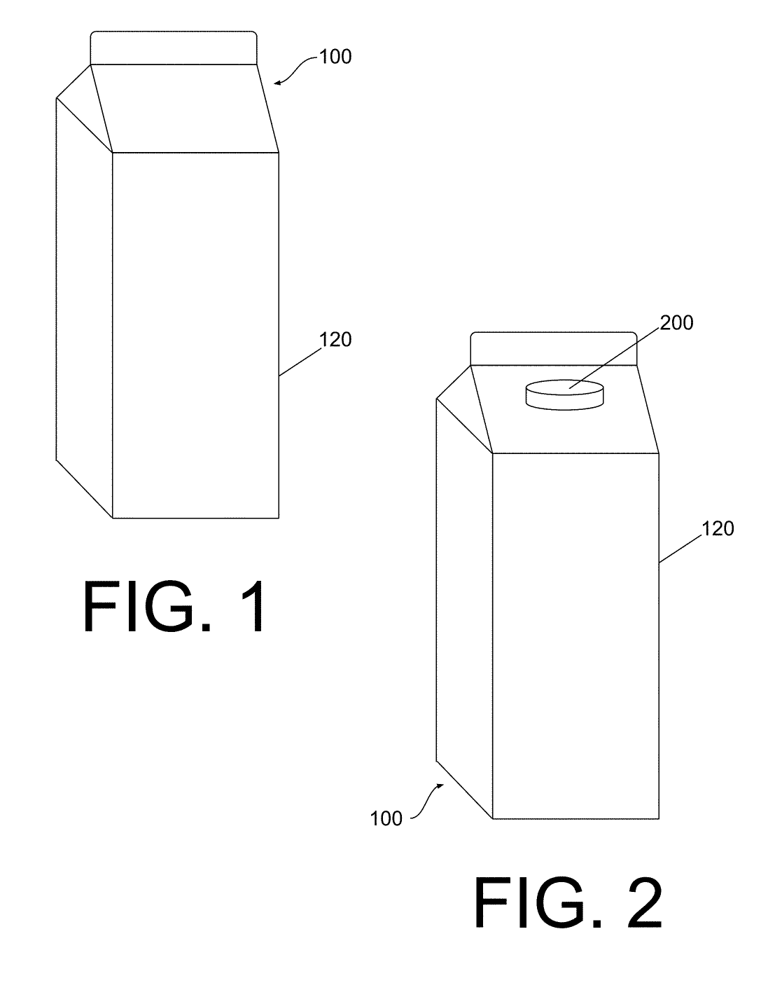

FIG. 1 depicts a carton 100 containing a non-dairy composition 110, where the carton 100 comprises a paperboard assembly 120, where in the non-dairy composition 110 is housed inside of the paperboard assembly 120.

The size and shape of the carton 100 can vary. For example, the carton 100 can be, but not limited to, a pint, quart, half gallon, or gallon sized. The shape of the carton 100 can be, but not limited to, a cuboid, box, sphere, tetrahedron, or lacking right angles and straight edges, as in squrounds (as so known as scround).

The paperboard assembly 120 has an exterior and a closed interior surface and can be made from, but not limited to, many materials: paperboard, duplex, white kraft, recycled and many more various plastics, or a composite.

The non-dairy composition 110 is a beauty product, health product, or cosmetic product. The non-dairy composition 110 can be, but not limited to, shampoo, soap, liquid soap, liquid gels, detergents, clay, salts, or hygiene products.

FIG. 2 shows a dispenser 200 affixed to the paperboard assembly 120 for allowing transfer of the non-dairy composition 110 between the interior surfaces of the paperboard assembly 120 to the outside of the carton 100. The dispenser 200 can be, but not limited to, a flip lid or snout fitting a pump. In one preferred embodiment, the dispenser is a cap.

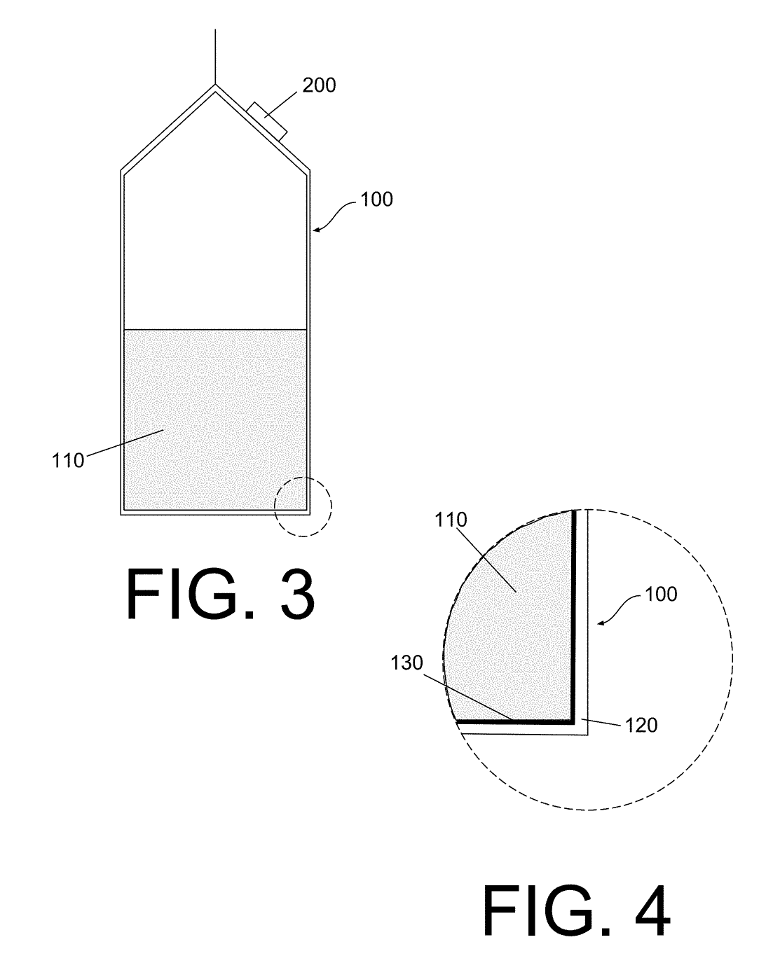

FIG. 3 is a cross-sectional view of the carton 100 housing the non-dairy composition 110 inside of the paperboard assembly 120.

FIG. 4 is an enlarged cross-sectional view of the carton 100, where the interior surface of the paperboard assembly 120 has a liner 130. The liner 130 creates a moisture barrier and serves to contain the non-dairy composition 110 within the paperboard assembly 120. The liner 130 also prevents the non-dairy composition 110 from coming in contact with liquids or other substances foreign to the contents housed inside of the carton 100. The liner 130 is made of a material that is waterproof or impervious to liquids—such as, but not limited to, a wax.

Using a carton 100 in the shape of a cuboid to beauty products provides an efficient, secure, and sterile way to store these cosmetic formulations and being able to ship these cosmetic formulations.

While the foregoing written description of the invention enables one of ordinary skill to make and use what is considered presently to be, the best mode thereof, those of ordinary skill will understand and appreciate the existence of variations, combinations, and equivalents of the specific embodiment, method, and examples, herein.

What is claimed:

1. A carton containing a non-dairy cosmetic composition, wherein the carton comprises a paperboard assembly, wherein the non-dairy composition is housed inside of the paperboard assembly.

2. The carton of claim 1, wherein a dispenser is affixed to the paperboard assembly.

3. The carton of claim 1, wherein the paperboard assembly comprises an exterior and a closed interior surface except for a dispensing opening.

4. The carton of claim 3, wherein the interior surface comprises a liner that prevents the transmission of the non-dairy cosmetic composition from the interior surface to the exterior surface and that prevents the transmission of outside elements from the exterior surface to the interior surface.

5. The carton of claim 3, wherein the liner comprises a material that is waterproof or impervious to liquids.

6. The carton of claim 1, wherein the non-dairy cosmetic composition comprises a beauty product.

7. The carton of claim 1, wherein the non-dairy cosmetic composition comprises beauty products.

8. The carton of claim 1, wherein the non-dairy cosmetic composition is a liquid beauty product.

9. The carton of claim 1, wherein the non-dairy cosmetic composition is a health product or a combination of health products.

10. The carton of claim 1, wherein the non-dairy cosmetic composition has a viscosity that allows for transferring through the dispenser.

11. The carton of claim 2, wherein the dispenser is affixed to the paperboard assembly at the dispensing opening.

12. The dispenser of claim 2, wherein the dispenser is a flip lid.

13. The dispenser of claim 2, wherein the dispenser is a dispenser pump.

14. The carton of claim 1, wherein the carton is in the shape of a cuboid.

15. A method of packaging a non-dairy cosmetic composition comprising inserting the non-dairy cosmetic composition into a carton and sealing the carton so that the non-dairy composition does not become contaminated and remains sterile.

16. The method of claim 15, wherein the carton comprises a paperboard assembly.

17. The method of claim 15, wherein a dispenser is affixed to the paperboard assembly.

18. The method of claim 15, wherein the non-dairy cosmetic composition is a liquid beauty product.

19. The method of claim 15, wherein the non-dairy cosmetic composition is a health product or combination of health products.

20. The method of claim 15, wherein the carton is in the shape of a cuboid.
